(19) United States
(12) Patent Application Publication
(10) Pub. No.: US 2025/0007067 A1
(43) Pub. Date: Jan. 2, 2025

(54) BATTERY PACK FOR VEHICLE

(71) Applicants: Hyundai Motor Company, Seoul (KR); Kia Corporation, Seoul (KR)

(72) Inventors: Hyun Chang KANG, Seoul (KR); Jeong Hun SEO, Suwon-SI (KR); Ji Woong JUNG, Anyang-Si (KR); Yoon Hyuk KANG, Seoul (KR); Jun Ho SUH, Gwacheon-Si (KR); Yong Hwan CHOI, Seoul (KR); Jun Young KANG, Hwaseong-Si (KR)

(73) Assignees: Hyundai Motor Company, Seoul (KR); Kia Corporation, Seoul (KR)

(21) Appl. No.: 18/389,142

(22) Filed: Nov. 13, 2023

(30) Foreign Application Priority Data
Jun. 29, 2023 (KR) 10-2023-0084428

(51) Int. Cl. H01M 50/244; H01M 10/48; H01M 50/143; H01M 50/249; H01M 50/271; H01M 50/367; H01M 50/383

(52) U.S. Cl. CPC H01M 50/244; H01M 10/486; H01M 50/143; H01M 50/249; H01M 50/271; H01M 50/367; H01M 50/383; H01M 2220/20

(57) ABSTRACT

A battery pack for a vehicle, includes a tray assembly; a plurality of battery modules arranged to form a planar grid in the tray assembly; and a pack cover coupled to an upper side of the tray assembly, and together with the tray assembly, forming a pack internal space to accommodate the battery modules therein, in which the battery modules arranged in the tray assembly includes first battery modules of which module outlets for discharging venting gas from insides thereof are formed in a longitudinal direction of the battery pack, and second battery modules of which module outlets are formed in a transverse direction, and the first battery module and the second battery module are alternately disposed inside the tray assembly to form the planar grid.

### CROSS REFERENCE TO RELATED APPLICATION

The present application claims priority to Korean Patent Application No. 10-2023-0084428, filed Jun. 29, 2023, the entire contents of which is incorporated herein for all purposes by this reference.

### BACKGROUND OF THE PRESENT DISCLOSURE

### Field of the Present Disclosure

The present disclosure relates to a structure for a battery pack mounted to a vehicle.

### Description of Related Art

An electric or hybrid vehicle is mounted with a battery that supplies electric power to a driving motor for driving the vehicle, in which the battery is mounted to the vehicle in a form of a battery pack that accommodates a plurality of battery modules, and the battery module includes a plurality of battery cells.

The battery cell may ignite for various reasons, and flames in the instant case may spread to the adjacent battery cells, causing thermal runaway.

Furthermore, a fire started in one battery module as described above may spread to other adjacent battery modules, resulting in thermal runway of the whole battery pack.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery pack for a vehicle, in which flames are structurally prevented from propagating to other neighboring battery modules when fire breaks out in the battery pack, effectively delaying the heat transfer between the battery modules and the thermal runaway of the battery pack.

According to an exemplary embodiment of the present disclosure, a battery pack for a vehicle includes: a tray assembly: a plurality of battery modules arranged to form a planar grid in the tray assembly; and a pack cover coupled to an upper side of the tray assembly, and together with the tray assembly, forming a pack internal space to accommodate the battery modules therein, the battery modules arranged in the tray assembly including first battery modules of which module outlets for discharging venting gas from insides thereof are formed in a longitudinal direction of the battery pack, and second battery modules of which module outlets are formed in a transverse direction of the battery pack.

The first battery module may include a first module top cover forming the module outlets at first and second end portions thereof in the longitudinal direction of the battery module; and the second battery module may include a second module top cover forming the module outlets at first and second end portions thereof in the transverse direction of the battery module.

The first module top cover may include a cover that covers an upper side of battery cells making up the battery module, and side coupling portions extended downwards from opposite lateral end portions of the cover, and is formed to include a uniform cross-section in the longitudinal direction of the battery module: the side coupling portions of the first module top cover may be coupled to upper end portions of opposite lateral finishing members of the battery module: a front end portion of the first module top cover may form the module outlet between a front finishing member of the battery module and the cover and the side coupling portion; and a rear end portion of the first module top cover may form the module outlet between a rear finishing member of the battery module and the cover and the side coupling portion.

The opposite lateral finishing members of the battery module may include endplates coupled pressurizing the stacked battery cells from both sides.

The cover and the side coupling portion of the first module top cover may be formed to include a trapezoidal cross-section which is uniform in the longitudinal direction of the battery module.

The first battery module mounted with the first module top cover may include a plurality of fireproof plates inserted between the stacked battery cells; and an upper end portion of the fireproof plate may be extended up to a bottom surface of the cover of the first module top cover.

The second module top cover may include a cover that covers an upper side of battery cells making up the battery module, a front end coupling portion extended downwards from a front end portion of the cover, and a rear end coupling portion extended downwards from a rear end portion of the cover, and is formed to include a uniform cross-section along the transverse direction of the second battery module: the front end coupling portion of the second module top cover may be coupled to an upper end portion of the front finishing member of the second battery module: the rear end coupling portion of the second module top cover may be coupled to an upper end portion of the rear finishing member of the battery module; and the module outlets may be formed between the opposite end portions of the second module top cover and the opposite lateral finishing members of the battery module.

The front finishing member of the battery module may include at least one of a module front cover and a front sensing block to sense voltage and temperature of the battery cells; and the rear finishing member of the battery module may include at least one of a module rear cover and a rear sensing block to sense the voltage and the temperature of the battery cells.

The cover, the front end coupling portion, and the rear end coupling portion of the second module top cover may be formed to include a trapezoidal cross-section which is uniform along the transverse direction of the battery module.

The second battery module mounted with the second module top cover may include a plurality of fireproof plates inserted between the stacked battery cells; and an upper end portion of the fireproof plate may include a saw-teeth shape where portions extended up to a bottom surface of the cover of the second module top cover and portions spaced from the bottom surface of the cover are repeatedly alternated.

The tray assembly may include: a lower plate disposed on a lower side of the battery modules: a plurality of external members coupled to an upper side of the lower plate and forming the pack internal space: a plurality of internal members provided inside the pack internal space and positioned between the battery modules arranged forming the planar grid; and a venting device provided in at least one of the external members to discharge venting gas outwards from the pack internal space.

The internal members may be lower in height than the battery modules, so that venting gas can flow from the battery module through an upper side of the internal members and be discharged out of the battery pack through the venting device.

The battery pack may further include a metal plate on an upper side of the lower plate to support a lower side of the battery modules and prevent the battery modules from being melted upon a breakout of fire.

The battery modules may be disposed above the metal plate with a thermal interface material (TIM) pad interposed therebetween.

The first module top cover for the first battery module and the second module top cover for the second battery module may be in surface-contact with a bottom surface of the pack cover.

The first battery module may include the module outlets formed between the pack cover and an opposite lateral finishing member and a front finishing member and between the pack cover and the opposite lateral finishing member and a rear finishing member as the opposite lateral finishing members of the battery module are extended up to a bottom surface of the pack cover.

The opposite lateral finishing members of the battery module may include endplates coupled pressurizing the stacked battery cells from both sides.

The second battery module may include the module outlets formed between a front finishing member, a rear finishing member, the pack cover, and lateral finishing members as the front finishing member and the rear finishing member of the battery module MD are extended up to a bottom surface of the pack cover.

The front finishing member of the battery module may include a module front cover; and the rear finishing member of the battery module may include a module rear cover.

The module front cover and the module rear cover may include elastically transformable portion on upper sides thereof to be elastically in contact with the bottom surface of the pack cover.

According to an exemplary embodiment of the present disclosure, flames are structurally prevented from propagating to other neighboring battery modules when fire breaks out in a battery pack, effectively delaying heat transfer between battery modules and thermal runaway of the battery pack.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a structure of a battery pack for a vehicle according to an exemplary embodiment of the present disclosure,

FIG. 2 illustrates the structure of the battery pack of FIG. 1 in more detail,

FIG. 3 illustrates a plurality of battery modules arranged to form a planar grid in a tray assembly of FIG. 1,

FIG. 4 illustrates the structure of the battery module accommodated in the battery pack of FIG. 1,

FIG. 5 illustrates a first battery module,

FIG. 6 is a cross-sectional view taken along line F6-F6 of FIG. 5,

FIG. 7 is a cross-sectional view taken along line F7-F7 of FIG. 5,

FIG. 8 illustrates a second battery module,

FIG. 9 is a cross-sectional view taken along line F9-F9 of FIG. 8,

FIG. 10 is a cross-sectional view taken along line F10-F10 of FIG. 8,

FIG. 11 is a cross-sectional view taken along line F11-F11 of FIG. 3,

FIG. 12 is a cross-sectional view taken along line F12-F12 of FIG. 3,

FIG. 13 illustrates a flow path of venting gas when fire breaks out in a battery module located at the center portion of a battery pack,

FIG. 14 illustrates an alternative example of a first battery module according to another exemplary embodiment of the present disclosure, and

FIG. 15 illustrates an alternative example of a second battery module according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings, in which the same or similar elements are denoted by the same reference numerals even though they are depicted in different drawings and redundant descriptions thereof will be avoided.

Suffixes “module” and “unit” put after elements in the following description are provided in consideration of only ease of description and do not have meaning or functions discriminated from each other.

In terms of describing the exemplary embodiments of the present disclosure, detailed descriptions of related art will be omitted when they may make the subject matter of the exemplary embodiments of the present disclosure rather unclear. Furthermore, the accompanying drawings are provided only for a better understanding of the exemplary embodiments of the present disclosure and are not intended to limit technical ideas of the present disclosure. Therefore, it should be understood that the accompanying drawings include all modifications, equivalents and substitutions within the scope and spirit of the present disclosure.

Terms such as “first” and “second” may be used to describe various components, but the components should not be limited by the above terms. Furthermore, the above terms are used only for distinguishing one component from another.

When it is described that one component is “connected” or “joined” to another component, it should be understood that the one component may be directly connected or joined to another component, but additional components may be present therebetween. However, when one component is referred to as being “directly connected,” or “directly coupled” to another component, it should be understood that additional components may be absent between the one component and another component.

Unless the context clearly dictates otherwise, singular forms include plural forms as well.

In an exemplary embodiment of the present disclosure, it should be understood that term “include” or “have” indicates that a feature, a number, a step, an operation, an element, a part, or the combination thereof described in the exemplary embodiments is present, but does not preclude a possibility of presence or addition of one or more other features, numbers, steps, operations, elements, parts or combinations thereof, in advance.

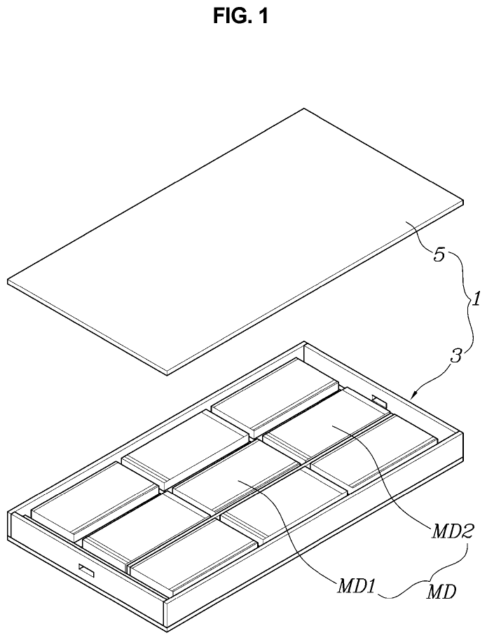

FIG. 1 illustrates a structure of a battery pack for a vehicle according to an exemplary embodiment of the present disclosure, in which a tray assembly 3 on a lower side accommodates a plurality of battery modules MD therein and couples with a pack cover 5 on an upper side thereof, so that the battery modules MD in the tray assembly 3 may be isolated and protected from the outside thereof.

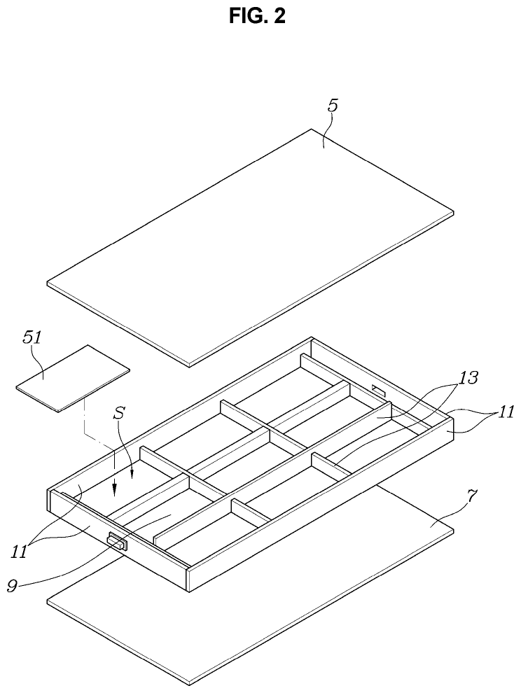

FIG. 2 illustrates the structure of the battery pack 1 of FIG. 1 in more detail, in which a plurality of external members 11 is coupled to the upper sides of a lower plate 7 and a metal plate 9 and together with the pack cover 5 forms a pack internal space S for accommodating the battery modules MD therein, and a plurality of internal members 13 is provided inside the external members 11.

Furthermore, in FIG. 2, the battery modules MD are omitted and a thermal interface material (TIM) pad 51 to be placed under the battery modules MD is illustrated.

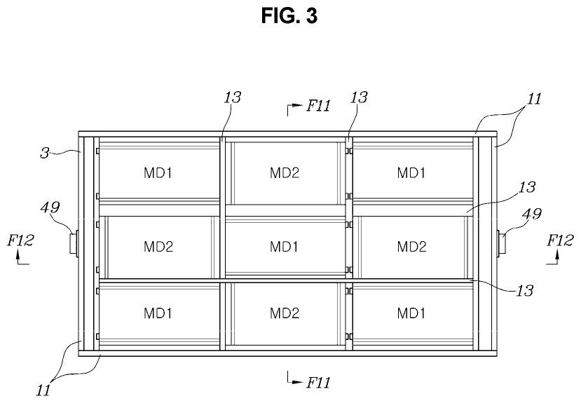

FIG. 3 illustrates the plurality of battery modules MD arranged to form a planar grid in the tray assembly 3 of FIG. 1. The battery modules MD shown in FIG. 3 are arranged in a planar orthogonal grid with nodes where the plurality of internal members 13 orthogonally cross each other.

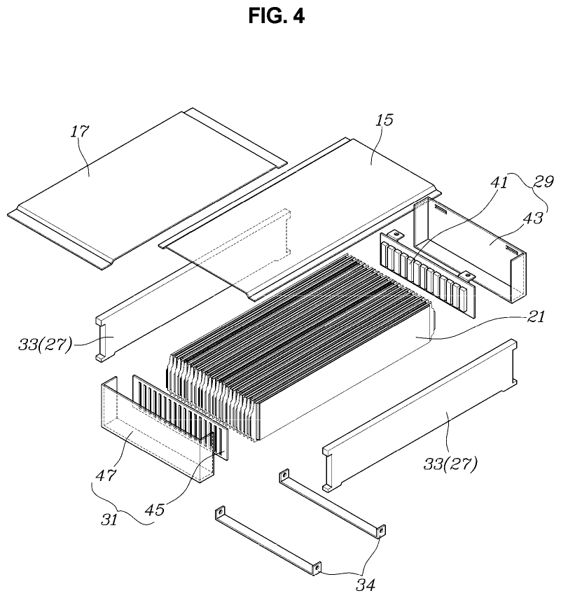

FIG. 4 illustrates the structure of the battery module MD accommodated in the battery pack 1 of FIG. 1. Here, one battery module MD is illustrated for easier understanding, but a first module top cover 15 and a second module top cover 17 are illustrated together for comparison.

In other words, substantially, the battery module MD configured with the first module top cover 15 becomes a first battery module MD1, and the battery module MD configured with the second module top cover 17 instead of the first module top cover 15 becomes the second battery module MD2.

For reference, FIG. 4 illustrates that lower brackets 34 are placed on the lower side and fastened connecting opposite endplates 33.

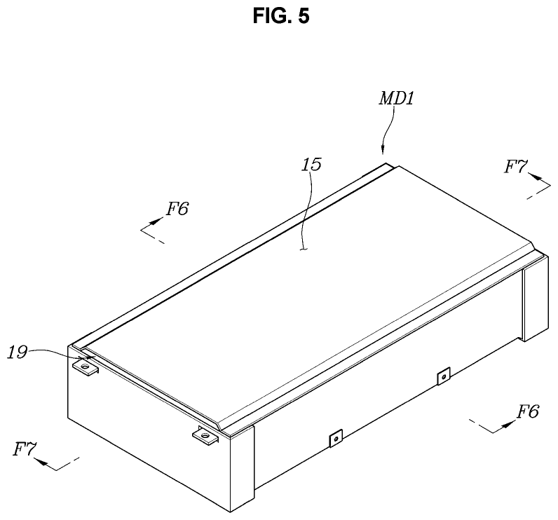

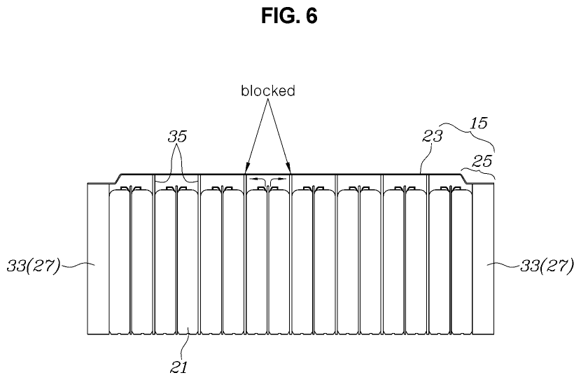

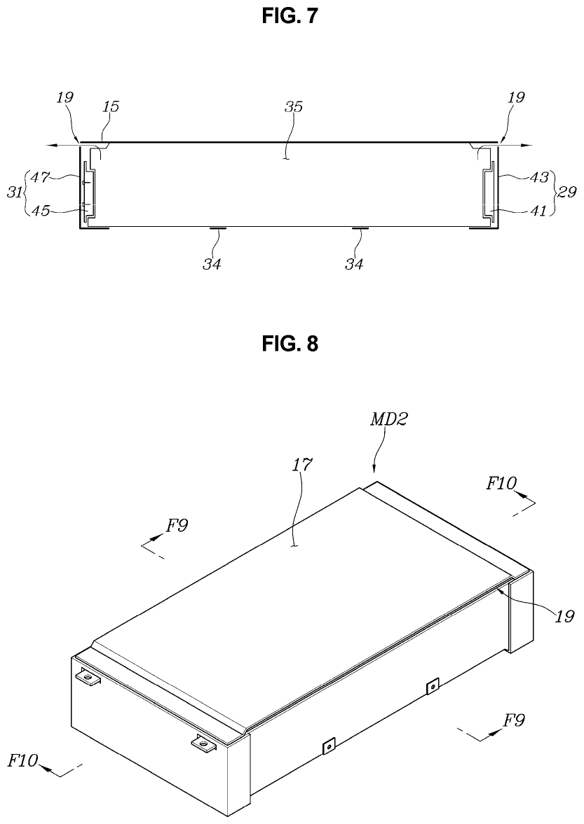

FIG. 5 illustrates the first battery module MD1, FIG. 6 is a cross-sectional view taken along line F6-F6 of FIG. 5, and FIG. 7 is a cross-sectional view taken along line F7-F7 of FIG. 5.

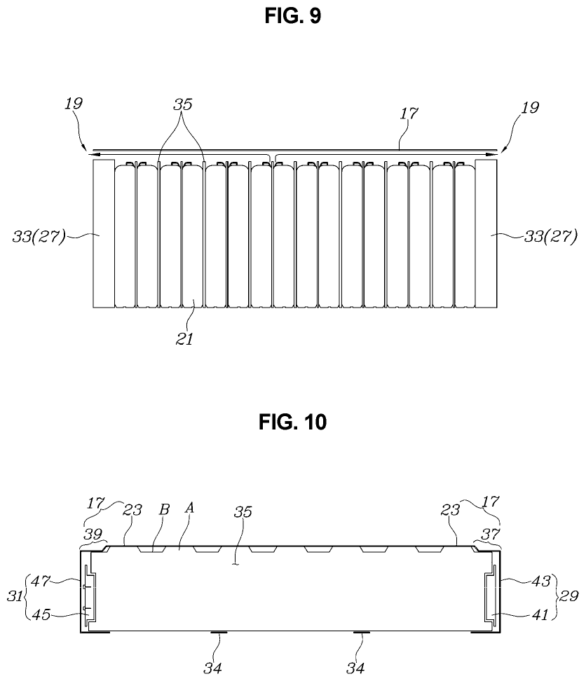

FIG. 8 illustrates the second battery module MD2, FIG. 9 is a cross-sectional view taken along line F9-F9 of FIG. 8, and FIG. 10 is a cross-sectional view taken along line F10-F10 of FIG. 8.

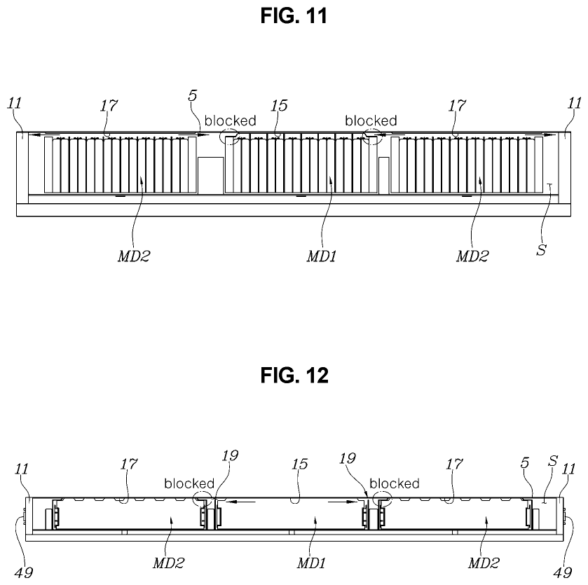

FIG. 11 is a cross-sectional view taken along line F11-F11 of FIG. 3, illustrating flow of venting gas when fire breaks out in the battery modules MD on both sides.

FIG. 12 is a cross-sectional view taken along line F12-F12 of FIG. 3, illustrating flow of venting gas when fire breaks out in the battery module MD in the center.

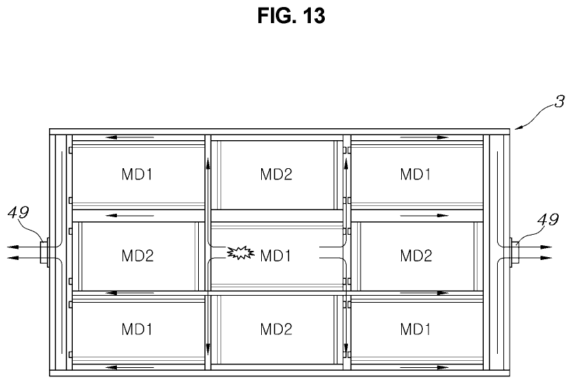

FIG. 13 illustrates a flow path of venting gas when fire breaks out in the battery module MD located at the center portion of the battery pack 1.

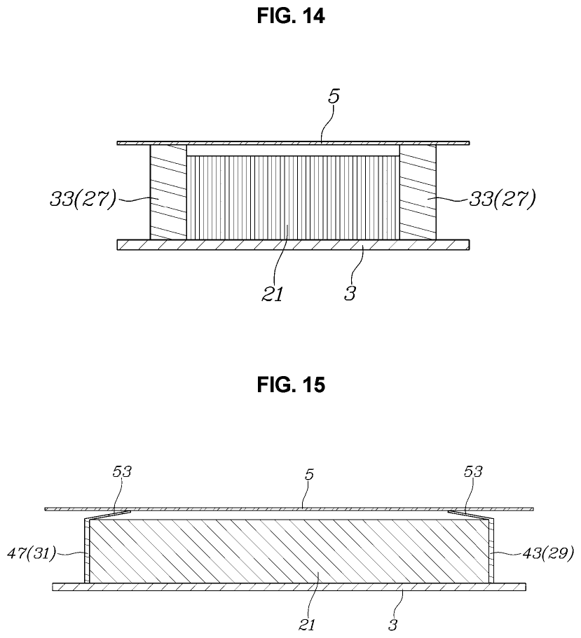

FIG. 14, and FIG. 15 illustrate other embodiments of the present disclosure, in which FIG. 14 shows an alternative example of the first battery module MD1, and FIG. 15 shows an alternative example of the second battery module MD2.

For reference, it will be understood that arrows with no separate marks in the accompanying drawings illustrate the flow of venting gas.

Referring to FIGS. 1 to 13, the battery pack 1 for a vehicle according to an exemplary embodiment the present disclosure includes the tray assembly 3: the plurality of battery modules MD arranged to form the planar grid in the tray assembly 3; and the pack cover 5 coupled to the upper side of the tray assembly 3, and together with the tray assembly 3, forming the pack internal space S to accommodate the battery modules MD therein.

The battery modules MD arranged in the tray assembly 3 include the first battery modules MD1 of which module outlets 19 for discharging the venting gas from the insides thereof are formed in a longitudinal direction of the battery pack, and the second battery modules MD2 of which the module outlets 19 are formed in a transverse direction thereof.

In the exemplary embodiment of the present disclosure, the first battery module MD1 and the second battery module MD2 are alternately arranged within the tray assembly 3, forming the planar grid.

In other words, according to an exemplary embodiment of the present disclosure, the battery modules MD are arranged forming the planar orthogonal grid in the pack internal space S formed by the tray assembly 3 and the pack cover 5, in which the battery modules MD are classified into two types of the first battery module MD1 and the second battery module MD2, and the first battery module MD1 and the second battery module MD2 are alternately arranged so that the battery modules MD adjacent to each other may be different in type from each other.

Therefore, as will be described later, when flames and venting gas are generated as fire breaks out in one of the plurality of first and second battery modules MD1 and MD2 making up the battery pack 1, the flames and the venting gas are guided to be discharged only through the module outlet 19 of the first battery module MD1 or the second battery module MD2. Because the module outlets 19 of the adjacent battery modules MD are perpendicularly misaligned without facing each other, the flames and the venting gas discharged through one module outlet 19 as described above are rapidly discharged to the outside while flowing along a channel formed above the internal member 13 without entering the module outlet 19 of the adjacent battery module MD. Accordingly, it is possible to effectively prevent or decrease the spread of fire from one battery module MD to other neighboring battery modules MD.

In the exemplary embodiment of the present disclosure, the first battery module MD1 includes the first module top cover 15 forming the module outlets 19 at both end portions thereof in the longitudinal direction thereof; and the second battery module MD2 includes the second module top cover 17 forming the module outlets 19 at both end portions thereof in the transverse direction thereof.

Besides the foregoing hole-like form previously formed to discharge the venting gas, the module outlet 19 according to an exemplary embodiment of the present disclosure may also be achieved by partially machining the module top cover or the like forming the external appearance of the battery module MD, so that the machined part remains closed under normal conditions but first breaks by pressure caused by the venting gas generated as fire breaks out so as to discharge the venting gas through the open machined part.

Here, the longitudinal direction of the battery module MD refers to a direction perpendicular to a stacking direction in which a plurality of battery cells 21 are stacked to make up the battery module MD, and the transverse direction refers to the stacking direction of the battery cells 21.

The first module top cover 15 includes a cover 23 that covers the upper side of the battery cells 21 making up the battery module MD, and side coupling portions 25 extended downwards from the opposite lateral end portions of the cover 23, and is formed to include a uniform cross-section in the longitudinal direction of the battery module MD.

The side coupling portions 25 of the first module top cover 15 are coupled to the upper end portions of opposite lateral finishing members 27 of the battery module MD: a front end portion of the first module top cover 15 forms the module outlet 19 between a front finishing member 29 of the battery module MD and the cover 23 and the side coupling portion 25; and a rear end portion of the first module top cover 15 forms the module outlet 19 between a rear finishing member 31 of the battery module MD and the cover 23 and the side coupling portion 25.

Here, the opposite lateral finishing members 27 of the battery module MD may be endplates 33 coupled pressurizing the stacked battery cells 21 from both sides.

In the exemplary embodiment of the present disclosure, the cover 23 and the side coupling portion 25 of the first module top cover 15 are formed having a trapezoidal cross-section which is uniform in the longitudinal direction of the battery module MD.

Therefore, a passage fluidically-communicating with the module outlet 19 and allowing the venting gas to smoothly flow and be discharged is easily formed above the battery cells 21, while securing the structural rigidity of the first module top cover 15.

The battery module MD mounted with the first module top cover 15 may include a plurality of fireproof plates 35 inserted between the stacked battery cells 21; and the upper end portion of the fireproof plate 35 may be extended up to the bottom surface of the cover 23 of the first module top cover 15.

Therefore, when fire breaks out in a certain battery cell 21 of the first battery module MD1, the fireproof plates 35 effectively block the propagation of the venting gas or flames to other neighboring battery cells 21 as shown in FIG. 6, and the venting gas is discharged through the module outlet 19 via a space between the battery cell 21 and the first module top cover 15 as shown in FIG. 7.

The second module top cover 17 includes a cover 23 covering the upper side of the battery cells 21 making up the battery module MD, a front end coupling portion 37 extended downwards from the front end portion of the cover 23, and a rear end coupling portion 39 extended downwards from the rear end portion of the cover 23, and is formed to include a uniform cross-section along the transverse direction of the battery module MD.

The front end coupling portion 37 of the second module top cover 17 is coupled to the upper end portion of the front finishing member 29 of the battery module MD: the rear end coupling portion 39 of the second module top cover 17 is coupled to the upper end portion of the rear finishing member 31 of the battery module MD; and the module outlets 19 are formed between the opposite end portions of the second module top cover 17 and the opposite lateral finishing members 27 of the battery module MD.

Here, the front finishing member 29 of the battery module MD may include at least one of a module front cover 43 and a front sensing block 41 to sense the voltage and the temperature of the battery cells 21, and the rear finishing member 31 of the battery module MD may include at least one of a module rear cover 47 and a rear sensing block 45 to sense the voltage and the temperature of the battery cells 21.

In other words, the front end coupling portion 37 of the second module top cover 17 may be coupled to the front sensing block 41 or the module front cover 43, and may also be coupled to both the front sensing block 41 and the module front cover 43.

Furthermore, the rear end coupling portion 39 of the second module top cover 17 may be coupled to the rear sensing block 45 or the module rear cover 47, and may also be coupled to both the rear sensing block 45 and the module rear cover 47.

For reference, the front sensing block 41 and the rear sensing block 45, both capable of being equipped with sensors, are combined and configured to sense the voltage, temperature, etc. of the battery cells 21 stacked for making up the battery module MD, and the module front cover 43 and the module rear cover 47 are provided to cover the front sensing block 41 and the rear sensing block 45.

In the exemplary embodiment of the present disclosure, the cover 23, the front end coupling portion 37, and the rear end coupling portion 39 of the second module top cover 17 are formed to include a trapezoidal cross-section which is uniform along the transverse direction of the battery module MD.

Therefore, a passage fluidically-communicating with the module outlet 19 and allowing the venting gas to smoothly flow and be discharged is easily formed above the battery cells 21, while securing the structural rigidity of the second module top cover 17.

The battery module MD mounted with the second module top cover 17 may include the plurality of fireproof plates 35 inserted between the stacked battery cells 21; and the upper end portion of the fireproof plate 35 may include a saw-teeth shape where portions A extended up to the bottom surface of the cover 23 of the second module top cover 17 and portions B spaced from the bottom surface of the cover 23 are repeatedly alternated.

Therefore, as shown in FIG. 9 and FIG. 10, when fire breaks out in one of the plurality of stacked battery cells 21, the flames and the venting gas are discharged through the module outlet 19 via the passage formed by the portions of the fireproof plates 35 spaced from the bottom surface of the cover 23 of the second module top cover 17, and the portions of the upper end portions of the fireproof plates 35, which are extended up to the bottom surface of the cover 23, are configured to partially block the propagation of the flames and venting gas.

Meanwhile, the tray assembly 3 includes the lower plate 7 disposed on the lower side of the battery modules MD: the plurality of external members 11 coupled to the upper side of the lower plate 7 and forming the pack internal space S: the plurality of internal members 13 provided inside the pack internal space S and positioned between the battery modules MD forming the planar grid; and a venting device 49 provided in at least one of the external members 11 to discharge the venting gas of the pack internal space S to the outside thereof.

For reference, according to the exemplary embodiment of the present disclosure, one venting device 49 may be provided in each of the front and rear external members 11 of the battery pack 1, and the venting device 49 may include a venting valve or the like, which blocks the pack internal space S of the battery pack 1 from the outside thereof to prevent infiltration of moisture or foreign materials under normal conditions, but opens to discharge the venting gas to the outside when the venting gas is generated due to fire and the like.

On the upper side of the lower plate 7, the metal plate 9 may additionally be provided to not only support the lower side of the battery module MD but also prevent the battery module MD from being melted when fire breaks out.

Furthermore, the battery modules MD may be disposed above the metal plate 9 with the TIM pad 51 interposed therebetween.

Therefore, heat generated in the battery module MD is rapidly transferred to the metal plate 9 through the TIM pad 51, maximizing the performance of cooling the battery module MD, and guiding the venting gas, the flames, etc. to move toward not the lower side of the battery module MD but the upper side when fire breaks out in the battery module MD.

Furthermore, the heights of the internal members 13 are lower than the height of the battery modules MD, so that the venting gas can flow from the battery module MD through the upper side of the internal members 13 and be discharged to the outside of the battery pack 1 through the venting device 49.

In other words, as shown in FIG. 13, when fire breaks out in the first battery module MD1 located at the center portion among the battery modules MD arranged in the battery pack 1, the venting gas discharged from the first battery module MD1 to the module outlet 19 is directed to the second battery modules MD2 adjacent to the first battery module MD1 on both sides. However, the module outlets 19 of the second battery modules MD2 are misaligned by 90 degrees with those of the first battery modules MD1, and thus the venting gas does not move to the second battery modules MD2 but moves to other places through the upper spaces of the internal members 13 between the first battery modules MD1 and the second battery modules MD2, ultimately reaching the venting device 49 through the upper spaces of the internal members 13 as indicated by the arrows.

Therefore, even though fire has started in one battery module MD, flames and high-temperature venting gas are rapidly discharged without directly propagating to the neighboring battery modules MD, effectively reducing or preventing a thermal runaway phenomenon in which the fire uncontrollably spreads to the neighboring battery modules MD.

In the exemplary embodiment of the present disclosure, the first module top cover 15 for the first battery module MD1 and the second module top cover 17 for the second battery module MD2 are configured to be in surface-contact with the bottom surface of the pack cover 5.

Therefore, as shown in FIG. 11 and FIG. 12, when the venting gas caused by fire or the like in the battery module MD is discharged through the module outlet 19, the venting gas does not flow into the space between the pack cover 5 and the first and second module top covers 15 and 17, but flows only through the upper space of the internal members 13, more effectively preventing the flames and the venting gas from spreading to other unfired battery modules MD.

FIG. 14, and FIG. 15 illustrate another exemplary embodiment of the present disclosure, and FIG. 14 shows the first battery module MD1 in which the opposite lateral finishing members 27 of the battery module MD are extended up to the bottom surface of the pack cover 5 so that the module outlets 19 may be formed between the pack cover 5 and the opposite lateral finishing member 27 and the front finishing member 29 and between the pack cover 5 and the opposite lateral finishing member 27 and the rear finishing member 31.

In other words, the cross-section of FIG. 14 is different from the cross-section of the first battery module MD1 shown in FIG. 11 in that the first module top cover 15 is not present and instead the opposite lateral finishing members 27 of the battery module MD are extended up to the bottom surface of the pack cover 5.

The opposite lateral finishing members 27 of the battery module MD may be achieved by endplates 33 coupled pressurizing the stacked battery cells 21 from both sides, or separate members provided surrounding both outermost sides of the battery module MD.

With the present configuration of excluding the first module top cover 15, the battery pack 1 becomes more compact and lightweight and the module outlets 19 of the first battery module MD1 are formed on both the front side and the rear side of the first battery module MD1.

FIG. 15 shows the second battery module MD2 in which the front finishing member 29 and the rear finishing member 31 of the battery module MD are extended up to the bottom surface of the pack cover 5 so that the module outlets 19 may be formed between the front finishing member 29, the rear finishing member 31, the pack cover 5, and the lateral finishing member 27.

The cross-section of FIG. 15 is different from the cross-section of the second battery module MD2 shown in FIG. 12 in that the second module top cover 17 is not present and instead the front finishing member 29 and the rear finishing member 31 of the battery module MD are extended up to the bottom surface of the pack cover 5.

The front finishing member 29 of the battery module MD may be achieved by the module front cover 43, and the rear finishing member 31 of the battery module MD may be achieved by the module rear cover 47.

In other words, without the second module top cover 17, the module front cover 43 and the module rear cover 47 are used to together with the pack cover 5 form a channel for the venting gas on the upper side of the second battery module MD2, forming the module outlets 19 at the opposite lateral sides of the second battery module MD2.

Therefore, with the present configuration of the battery pack 1 excluding the second module top cover 17, the battery pack 1 becomes more compact and lightweight and the module outlets 19 of the second battery module MD2 are formed on both the lateral sides of the second battery module MD2.

Each of the module front cover 43 and the module rear cover 47 according to the present exemplary embodiment includes an elastically transformable portion 53 on the upper side thereof to be elastically in contact with the bottom surface of the pack cover 5.

Therefore, in the battery pack 1 assembled by pressurizing the pack cover 5 from the upper side, the elastically transformable portion 53 is elastically in contact with the bottom surface of the pack cover 5, so that the channel can have airtightness against the flames and the venting gas, more effectively preventing the venting gas and the flames from spreading to other neighboring battery modules MD.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery pack for a vehicle, the battery pack comprising:
a tray assembly;
a plurality of battery modules arranged to form a planar grid in the tray assembly; and
a pack cover coupled to an upper side of the tray assembly, and together with the tray assembly, forming a pack internal space to accommodate the battery modules therein,
wherein the battery modules arranged in the tray assembly includes:
first battery modules formed in a longitudinal direction of the battery pack and includes at least one first module outlet for discharging venting gas from insides thereof; and
second battery modules formed in a transverse direction of the battery pack and including at least a second module outlet for discharging the venting gas from insides thereof.

2. The battery pack of claim 1,
wherein the first battery modules include a first module top cover forming the at least one first module outlet at at least one of first and second end portions of the first module top cover in a longitudinal direction of the first battery modules, and
wherein the second battery modules include a second module top cover forming the at least one second module outlet at at least one of first and second end portions of the second module top cover in a transverse direction of the first battery modules.

3. The battery pack of claim 2,
wherein the first module top cover includes a cover that covers an upper side of battery cells making up the first battery modules, and side coupling portions extended downwards from opposite lateral end portions of the cover, and is formed to include a uniform cross-section in the longitudinal direction of the first battery modules,
wherein the side coupling portions of the first module top cover are coupled to upper end portions of opposite lateral finishing members of the first battery modules,
wherein the front end portion of the first module top cover forms one of the at least one first module outlet between a front finishing member of the first battery modules and the cover and the side coupling portions, and
wherein the rear end portion of the first module top cover forms one of the at least one first module outlet between a rear finishing member of the first battery modules and the cover and the side coupling portions.

4. The battery pack of claim 3, wherein the opposite lateral finishing members of the first battery modules include endplates coupled pressurizing the stacked battery cells from first and second sides thereof.

5. The battery pack of claim 3, wherein the cover and the side coupling portions of the first module top cover are formed to include a trapezoidal cross-section which is uniform in the longitudinal direction of the first battery modules.

6. The battery pack of claim 3,
wherein the first battery modules mounted with the first module top cover includes a plurality of fireproof plates inserted between the stacked battery cells, and
wherein an upper end portion of the fireproof plates is extended up to a bottom surface of the cover of the first module top cover.

7. The battery pack of claim 2,
wherein the second module top cover includes a cover that covers an upper side of battery cells making up the second battery modules, the front end coupling portion extended downwards from a front end portion of the cover, and the rear end coupling portion extended downwards from a rear end portion of the cover, and is formed to include a uniform cross-section along a transverse direction of the second battery modules,
wherein the front end coupling portion of the second module top cover is coupled to an upper end portion of a front finishing member of the second battery modules,
wherein the rear end coupling portion of the second module top cover is coupled to an upper end portion of a rear finishing member of the second battery modules, and
wherein the first and second module outlets are formed between opposite end portions of the second module top cover and opposite lateral finishing members of the battery modules.

8. The battery pack of claim 1,
wherein a front finishing member of the battery modules includes at least one of a module front cover and a front sensing block to sense voltage and temperature of the battery cells, and
wherein a rear finishing member of the battery modules includes at least one of a module rear cover and a rear sensing block to sense the voltage and the temperature of the battery cells.

9. The battery pack of claim 7, wherein the cover, the front end coupling portion, and the rear end coupling portion of the second module top cover are formed to include a trapezoidal cross-section which is uniform along the transverse direction of the second battery modules.

10. The battery pack of claim 7,
wherein the second battery modules mounted with the second module top cover includes a plurality of fireproof plates inserted between the stacked battery cells, and
wherein an upper end portion of the fireproof plate includes a saw-teeth shape where portions extended up to a bottom surface of the cover of the second module top cover and portions spaced from the bottom surface of the cover are repeatedly alternated.

11. The battery pack of claim 1, wherein the tray assembly includes:
a lower plate disposed on a lower side of the battery modules;
a plurality of external members coupled to an upper side of the lower plate and forming the pack internal space;
a plurality of internal members provided inside the pack internal space and positioned between the battery modules arranged forming the planar grid; and
a venting device provided in at least one of the external members to discharge the venting gas outwards from the pack internal space.

12. The battery pack of claim 11, wherein the internal members are lower in height than the battery modules, so that the venting gas flows from the battery modules through an upper side of the internal members and be discharged out of the battery pack through the venting device.

13. The battery pack of claim 11, further including a metal plate on an upper side of the lower plate to support a lower side of the battery modules and prevent the battery modules from being melted upon a breakout of fire.

14. The battery pack of claim 13, wherein the battery modules are disposed above the metal plate with a thermal interface material (TIM) pad interposed therebetween.

15. The battery pack of claim 2, wherein the first module top cover for the first battery modules and the second module top cover for the second battery modules are in surface-contact with a bottom surface of the pack cover.

16. The battery pack of claim 1, wherein the first battery modules include the at least one first module outlet formed between the pack cover and an opposite lateral finishing member and a front finishing member and between the pack cover and the opposite lateral finishing member and a rear finishing member as the opposite lateral finishing member of the battery modules are extended up to a bottom surface of the pack cover.

17. The battery pack of claim 16, wherein the opposite lateral finishing member of the battery modules includes endplates coupled pressurizing the stacked battery cells from both sides.

18. The battery pack of claim 1, wherein the second battery module includes the at least one second module outlet formed between a front finishing member, a rear finishing member, the pack cover, and lateral finishing members as the front finishing member and the rear finishing member of the battery modules are extended up to a bottom surface of the pack cover.

19. The battery pack of claim 18,
wherein the front finishing member of the battery modules include a module front cover, and
wherein the rear finishing member of the battery modules include a module rear cover.

20. The battery pack of claim 19, wherein the module front cover and the module rear cover include elastically transformable portion on upper sides thereof to be elastically in contact with the bottom surface of the pack cover.
